(19) United States
(12) Patent Application Publication
(10) Pub. No.: US 2014/0027521 A1
(43) Pub. Date: Jan. 30, 2014

(54) INSERT FOR ENCLOSING ELECTRONICS

(71) Applicant: YUP 2 ATX, LLC, Austin, TX (US)

(72) Inventors: James Joseph PEDICANO, Austin, TX (US); Ron YUHL, Warren, NJ (US)

(73) Assignee: YUP 2 ATX, LLC, Austin, TX (US)

(21) Appl. No.: 14/033,857

(22) Filed: Sep. 23, 2013

Related U.S. Application Data
(63) Continuation of application No. 13/487,800, filed on Jun. 4, 2012.
(60) Provisional application No. 61/494,028, filed on Jun. 7, 2011.

(51) Int. Cl. G06K 19/077

(52) U.S. Cl. CPC G06K 19/07762
USPC 235/492

(57) ABSTRACT

The present invention may include an insert with a cavity or recess configured to contain electronics. The insert may include shapes, sizes, and configurations such as a disk, envelope, packet, pod, case, casing, shell, cocoon or capsule. The insert may be inserted into a stretchable object. In one embodiment, the insert may be of a shape, size and configuration to contain a RFID device and be inserted into an elastic wristband.

### CROSS-REFERENCE TO RELATED APPLICATIONS

This application is a Continuation of U.S. Non-Provisional patent application Ser. No. 13/487,800 filed Jun. 4, 2012 entitled “Insert for Enclosing Electronics”, which claims priority based upon prior U.S. Provisional Patent Application Ser. No. 61/494,028 filed Jun. 7, 2011 in the name of James Joseph Pedicano and Ron Yuhl, entitled “Bracelet for Storing and Transmitting Information,” the disclosure of each of which are incorporated herein by reference.

### BACKGROUND OF THE INVENTION

The present invention relates generally to packaging and, more particularly, to the packaging of electronics into stretchable objects.

Existing technology is not well suited for combining electronics into stretchable objects. For example, commercially available chips that are designed for use in contactless payment systems are sold in a molded package, similar, if not identical, to the NOA3 package offered by Nedcard Ltd. of Belgium. A representative package size is 5.15 mm×8.0 mm×0325 mm. The chip size is typically 2 mm×2 mm×0.015 mm though there is significant variation between manufacturers. Because standard molded packaging is designed to protect the integrated circuit during fabrication and is designed for use on a PVC laminated card, traditional molded packaging is typically stiff and very robust and, as a result, not suitable for use in a stretchable object.

As is apparent to those skilled in the art, there are numerous obstacles to embedding electronics, such as RFID microchips and antennas, into a stretchable object, such as an elastic wristband. With respect to an elastic wristband, for example, the wristband must possess the requisite elasticity to stretch when drawn over the user's hand, but must also be UV stable enough to protect the RFID chip and antenna. The wristband must be durable enough to withstand the rigors of daily living, including activities such as exercise and bathing, while protecting the integrity of the electronics. To maximize market acceptance, the wristband must be of a size commensurate with currently available wristbands. The size of the wristband may require the electronics to be smaller than otherwise permissible. Also, the electronics must be configured on or in the wristband in such a manner that the stretching of the band during use does not damage elements of the electronics such as a microchip, antenna, or the connection therebetween.

Other issues related to the combination of stretchable objects and electronics arise in the manufacturing process. During the manufacturing of an elastic wristband that contains an RFID device, for example, the microchip and antenna of the RFID device must be protected so that RFID device is not damaged or destroyed. Similarly, the connection between the microchip and antenna of the RFID device must not be dislodged or compromised. Also, the microchip and antenna package must be properly adhered to the wristband, either temporarily during the molding process if the package is included within the mold, or permanently if the package is adhered to the outside of the wristband. Resins must be selected which match the “skin feel” of currently available wristbands but that are also compatible with the microchip and antenna. In addition, the finished product must be aesthetically pleasing and appear the same as commercially available wristbands, including matching the color, indented lettering and, if the wristband is manufactured in two parts, making the two portions of the wristband indistinguishable. Another concern is that since the wristband must be relatively soft for the wristband to be sufficiently flexible, the components embedded in the wristband may require additional protection against external pressures in order to avoid damage the wristband is worn on the wrist.

### SUMMARY OF THE INVENTION

A device and method which implements a preferred embodiment of the present invention includes an insert with a cavity configured to contain electronics. The insert may include shapes, sizes, and configurations such as a disk, envelope, packet, pod, case, casing, shell, cocoon or capsule. The cavity may include other shapes, sizes, and configurations such as a pocket, pouch, receptacle, recess, depression, void, groove, channel or indention. The insert may be inserted into a stretchable object. In one embodiment, the insert may be of a shape, size and configuration to contain a RFID device and be inserted into an elastic wristband.

In one embodiment, an insert for containing electronics within a stretchable object comprises an elongated disk having a width within the range of 0.6 to 0.1 inches and a top surface, a cavity within the elongated disk, and an opening to the cavity on the top surface of the elongated disk.

In one embodiment, a capsule for containing electronics within a stretchable object comprises a first elongated sheet with a convex inner surface and concave outer surface, a second elongated sheet with a concave inner surface and a convex outer surface, the concave inner surface including a recess, and a hinge connecting the proximal end of the first elongated sheet and the proximal end of the second elongated sheet such that the convex inner surface of the first elongated sheet may be rotated to contact at least a portion of the concave inner surface of the second elongated sheet.

In one embodiment, a casing for containing electronics within a stretchable object comprises a first elongated plate and a second elongated plate. The first elongated plate includes a first end, a second end, and an inner surface. In addition, the first elongated plate includes a first connecting mechanism on its inner surface near its first end and a second connecting mechanism on its inner surface near its second end. The second elongated plate also includes a first end, a second end, an inner surface, a first complementary connecting mechanism on its inner surface near its first end, and a second complementary connecting mechanism on its inner surface near its second end. Either the inner surface of the first elongated plate or the inner surface of the second elongated plate includes a recess. In addition, the distance between the first complementary connecting mechanism and the second complementary connecting mechanism is less than the distance between the first connecting mechanism and the second connecting mechanism such that the first complementary connecting mechanism may mate with the first connecting mechanism and the second complementary connecting mechanism may mate with the second connecting mechanism only with the inner surface of the second elongated plate having a convex curvature and the inner surface of the first elongated plate having a concave curvature.

As may be appreciated by one having ordinary skill in the art, there is a significant need for an insert that will protect electronics, such as an RFID device, from damage in combining the electronics with a stretchable object, from stretching and twisting as the stretchable object is used, and from wear and tear that will decrease the durability and life span of the stretchable object.

### BRIEF DESCRIPTION OF THE DRAWINGS

Before drawings are presented it is to be understood that the invention is not limited to the details of the assembly and arrangements of the components set forth in the following description or illustrated in the drawings. The invention is capable of its major components being carried out and assembled in various ways. For a more complete understanding of the present invention, and the advantages thereof, reference is now made to the following descriptions, taken in conjunction with the accompanying drawings but not limited to represent the whole invention, in which:

FIG. 1A shows an isometric view of an insert with a cavity in one embodiment of the present invention.

FIG. 1B shows a top view of an insert with a curve along its length in one embodiment of the present invention.

FIG. 2 shows a top view of the insert in one embodiment of the present invention.

FIG. 3A shows a top view of an insert comprised of two pieces in one embodiment of the present invention.

FIG. 3B shows a top view of an insert comprised of two pieces in one embodiment of the present invention.

FIG. 4 shows an isometric view of an elastic wristband in one embodiment of the present invention.

FIG. 5A shows an isometric view of a first elastic band in one embodiment of the present invention.

FIG. 5B shows an isometric view of an elastic wristband with a secondary molding in one embodiment of the present invention.

### DETAILED DESCRIPTION

The present invention may include an insert with a cavity configured to contain electronics. The insert may include shapes, sizes, and configurations such as a disk, envelope, packet, pod, case, casing, shell, cocoon or capsule. The cavity may include other shapes, sizes, and configurations such as a pocket, pouch, receptacle, recess, depression, void, groove, channel or indention. The insert may be inserted into a stretchable object. In one embodiment, the insert may be of a shape, size and configuration to contain a RFID device and be inserted into an elastic wristband.

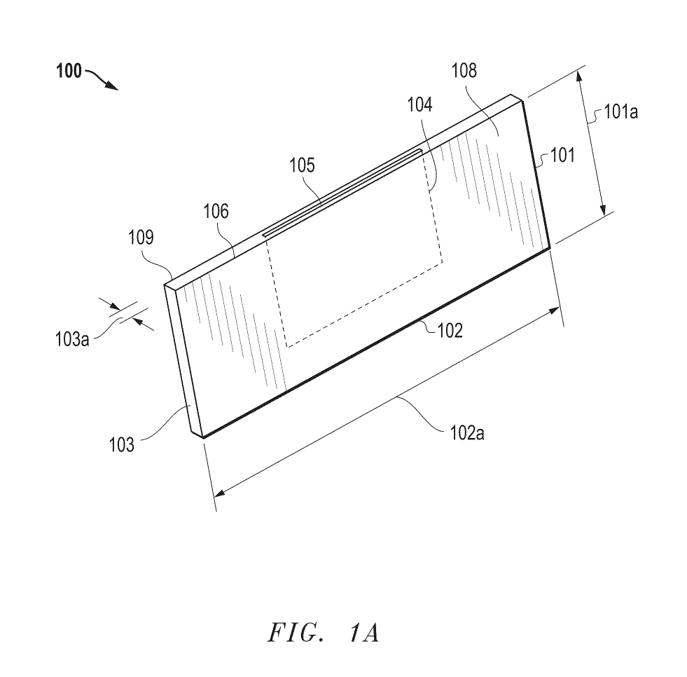

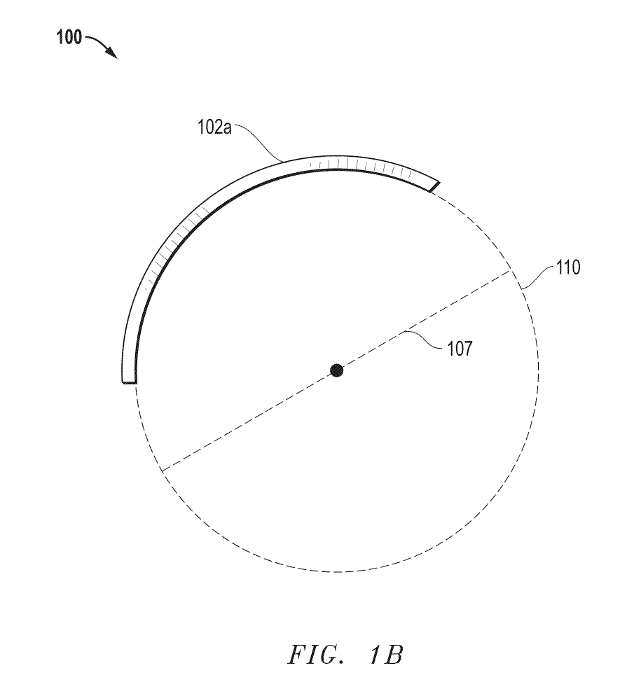

Reference is now made to FIG. 1A which shows an isometric view of an insert 100 with a cavity 104 in one embodiment of the present invention. The insert 100 may be in the shape of one or more elongated plates that may be a rectangular, smooth, flat, relatively thin body of uniform thickness with at least some rigidity. In other embodiments, the insert 100 may be in the shape of one or more elongated sheets that may be relatively smooth and thin and may have at least some flaccidity. The insert 100 may include a bottom surface 102, a top surface 106, a left-side surface 103, a right-side surface 101, a front surface 108, and a back surface 109. The insert 100 may have a width 103a equal the distance between the front surface 108 and the back surface 109. In one embodiment, the length 102a of the insert 100 may be in the range of 2.0 to 2.5 inches. In one embodiment, the height 101a of the insert 100 may be approximately 0.5 inches. In one embodiment, the width 103a of the insert 100 may be in the range of 0.06 to 0.10 inches. It can be appreciated that other embodiments of the insert 100 may include other shapes, sizes, and configurations such as a disk, envelope, packet, pod, case, casing, shell, cocoon or capsule. In other embodiments, for example, the insert 100 may have one or more rounded corners. In one embodiment, the insert 100 may be curved along its length 102a.

The insert 100 may also include at least one opening 105 and at least one cavity 104. In one embodiment, the opening 105 may be positioned on the top surface 106 or the bottom surface 102 of the insert 100. The opening 105 may provide access to the cavity 104. The cavity 104 may be configured to hold electronics, such as an RFID device. In one embodiment, for example, an RFID device including a microchip and an antenna may be inserted into the cavity 104 through the opening 105. In one embodiment, the cavity 104 may be rectangular in shape. In one embodiment, the cavity 104 may be approximately 2.0 inches in length, 0.39 to 0.5 inches in height, and 0.032 to 0.040 inches in width. In one embodiment, the cavity may be approximately centered between the front surface 108 and the back surface 109 of the insert 100. In one embodiment, the cavity 104 may be approximately centered between the left-side surface 103 and the right-side surface 101 of the insert 100. It can be appreciated that other embodiments of the cavity 104 may include other shapes, sizes, and configurations such as a pocket, pouch, receptacle, recess, depression, void, groove, channel or indention. In one embodiment, a lid (not shown) may be placed over the opening 105. In other embodiments, the cavity 104 may be closed by molding over the opening 105.

The insert 100 may be comprised of material with a hardness that is greater than the hardness of the stretchable object that the insert 100 is to be inserted into. The insert 100 may be comprised of materials with different hardness levels, however. For example, the insert 100 may be comprised of thermal plastic elastomers (TPE), polyvinyl chloride (PVC), poly carbonate, styrene, acrylonitrile butadiene styrene (ABS), polypropylene and/or polyethylene.

Reference is now made to FIG. 1B which shows a top view of an insert 100 with a curve along its length 102a in one embodiment of the present invention. In this embodiment, the length 102a of the insert 100 is shown in the shape of a portion of the circumference of a circle 110. In one embodiment, the diameter 107 of such a circle may be in the range of 2.25 to 3.0 inches.

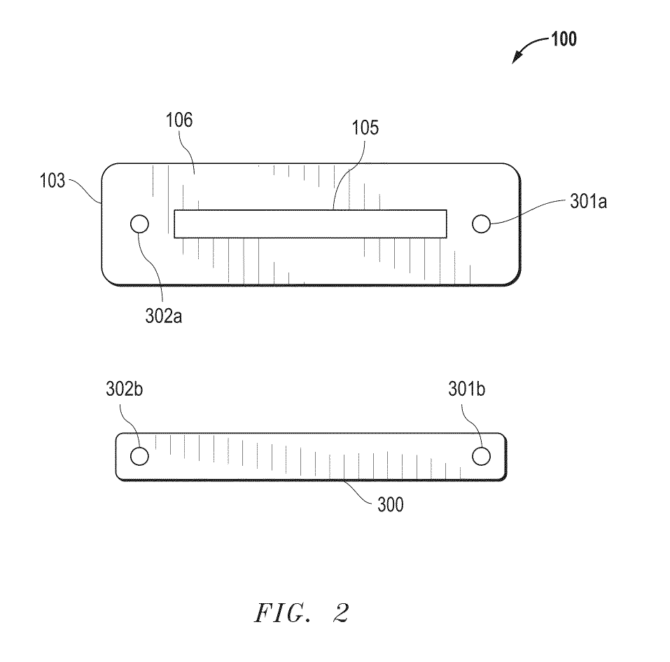

Reference is now made to FIG. 2 which shows a top view of the insert 100 and a lid 300 in one embodiment of the present invention. In this embodiment, the top surface 106 of the insert 100 includes an opening 105. The opening 105 is shown to be elongated and extends along a portion of the top surface 106 of the insert 100. The top surface 106 of the insert 100 also includes mounting mechanisms 301a and 301b. The mounting mechanisms 301a and 302a are each shown to be located between one end of the opening 105 and one end of the insert 100. The lid 300 may be placed over the opening 105. The lid 300 is shown to include mounting mechanisms 301b and 302b which may mate with complementary mounting mechanisms 301a and 302a, respectively, of the insert 100. For example, in one embodiment, the mounting mechanisms 301a and 302a may consist of posts and the mounting mechanisms 301b and 302b may consist of holes which may be snapped over the posts of the mounting mechanisms 301a and 302a. In other embodiments, the mounting mechanisms 301a and 302a, and 301b and 302b, may consist of other shapes, sizes and configurations for connecting the lid to the insert such as, for example, clasps, Velcro, snaps, clips, fasteners, hooks, or buttons.

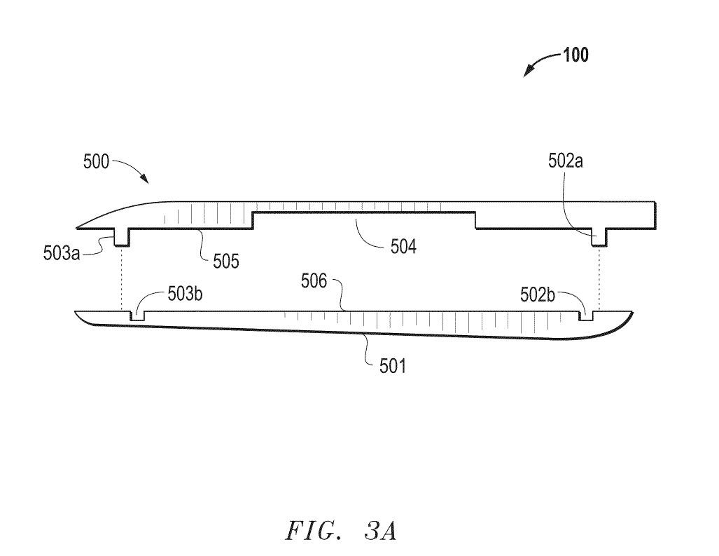

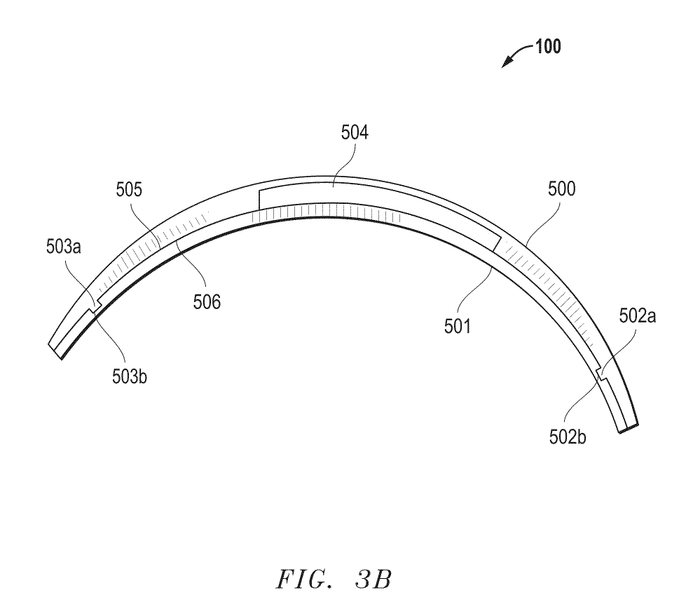

Reference is now made to FIG. 3A which shows a top view of an insert 100 comprised of two pieces in one embodiment of the present invention. In this embodiment, the insert 100 may consist of a first elongated plate 500 and a second elongated plate 501. The inner surface 505 of the first elongated plate 500 may include a recess 504. In other embodiments, the inner surface 506 of the second elongated plate 501 may include a recess 504. The first elongated plate 500 may include a first connecting mechanism 502a that is configured to connect to a complimentary first connecting mechanism 502b of the second elongated plate 501. The first elongated plate 500 may include a second connecting mechanism 503a that is configured to connect to a complimentary second connecting mechanism 503b of the second elongated plate 501. In one embodiment, the first connecting mechanism 502a and the second connecting mechanism 503a may be located at opposite ends of the first elongated plate 500 and the first complimentary connecting mechanism 502b and the second complimentary connecting mechanism 503b may be located at opposite ends of the second elongated plate 500. In one embodiment, the first connecting mechanism 502a and the second connecting mechanism 503a may be located along the inner surface 505 of the first elongated plate 500 and the first complimentary connecting mechanism 502b and the second complimentary connecting mechanism 503b may be located along the inner surface 506 of the second elongated plate 500. In one embodiment, the distance between the first connecting mechanism 502a and the second connecting mechanism 503a may be greater than the distance between the first complimentary connecting mechanism 502b and the second complimentary connecting mechanism 503b. In one embodiment, the difference in the distance between the first connecting mechanism 502a and the second connecting mechanism 503a and the distance between the first complimentary connecting mechanism 502b and the second complimentary connecting mechanism 503b may be such that the first connecting mechanism 502a may connect with the first complimentary connecting mechanism 502b and the second connecting mechanism 503a may connect with the second complimentary connecting mechanism 503b if the first elongated plate 500 and the second elongated plate 501 are curved. For example, the first elongated plate 500 may be curved such that its inner surface 505 is concave and the second elongated plate 501 may be curved such that its inner surface 506 is convex.

Reference is now made to FIG. 3B which shows a top view of an insert 100 comprised of two pieces in one embodiment of the present invention. In this embodiment, the first elongated plate 500 is shown to be curved such that its inner surface 505 is concave and rests against the inner surface of the second elongated plate 501. The second elongated plate 501 is shown to be curved such that its inner surface 506 is convex. The first connecting mechanism 502a is shown to have connected with the first complimentary connecting mechanism 502b and the second connecting mechanism 503a is shown to have connected with the second complimentary connecting mechanism 503b. When the first elongated plate 500 is connected to the second elongated plate 501, the recess 400 may to be enclosed by the inner surface 506 of the second elongated plate 501.

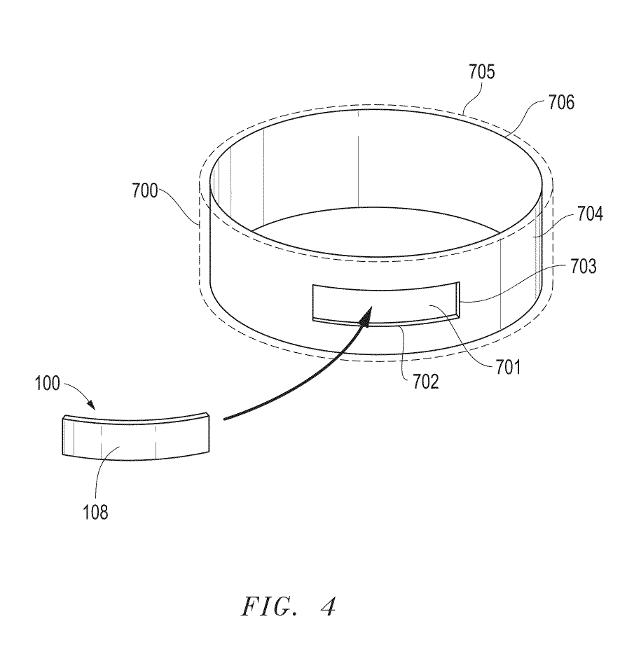

Reference is now made to FIG. 4 which shows an isometric view of an elastic wristband 700 in one embodiment of the present invention. The elastic wristband 700 is one example of a stretchable object that the insert 100 may be inserted into. The elastic wristband 700 may be comprised of a first elastic band 706 and a second elastic band 705. The first elastic band 706 may contain a depression 701 on its outer surface 704. The depression 701 may include one or more edges 702 formed from the thickness of the first elastic band 706. The depression 701 may also include a back wall 703 formed from the recessed portion of the outer surface 704 of the first elastic band 706. The shape of the depression 701 may be configured to contain the insert 100. In one embodiment, the second elastic band 705 may be molded over the all or a portion of the outer surface 704 of the first elastic band 706. The molding of the second elastic band 705 over all or a portion of the outer surface 704 of the first elastic band 706 may enclose the insert 100 within the depression 701. In one embodiment, the second elastic band 705, rather than the first elastic band, may include the depression 701.

In one embodiment, the insert 100 may include writing on its front surface 108, or on a lid or cover (not shown) covering at least a portion of the insert's 100 front surface. In addition, the elastic wristband 700 and/or at least a portion of the second elastic band 705 may be transparent so that the writing on the insert 100 may be viewed with the insert 100 contained within the elastic wristband 700.

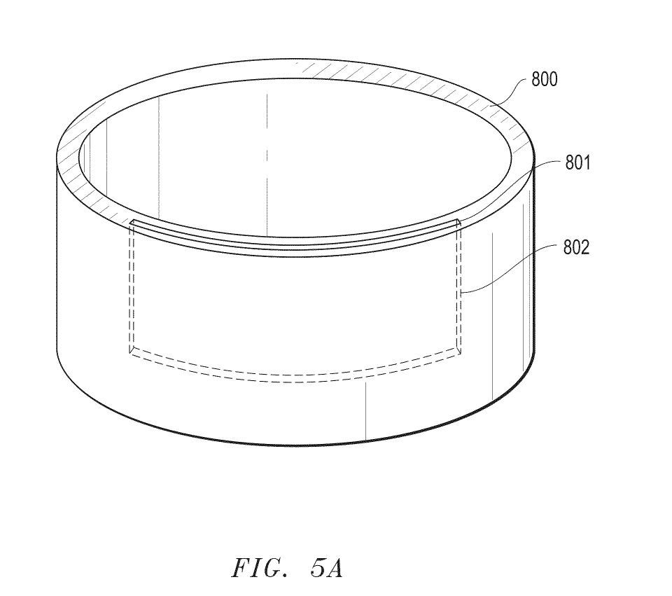

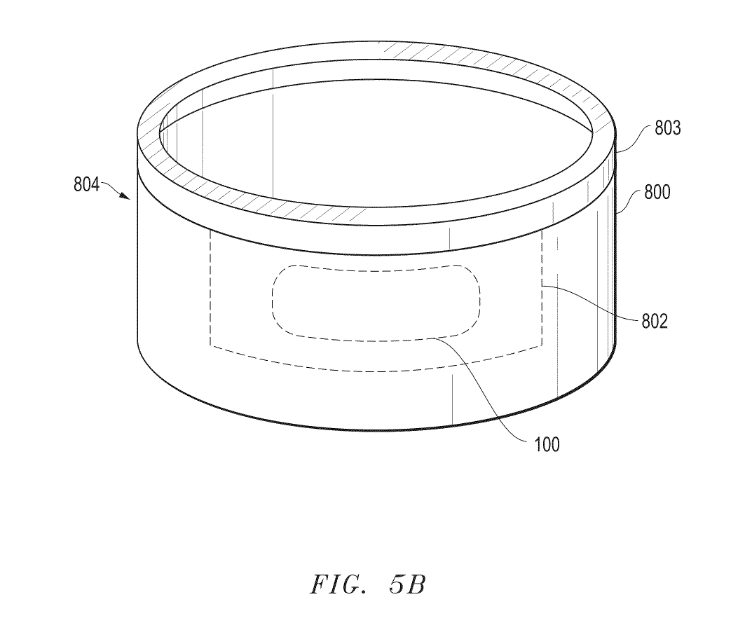

Reference is now made to FIG. 5A which shows an isometric view of a first elastic band 800 in one embodiment of the present invention. In this embodiment, the first elastic band 800 includes a depression 802 within the body of the first elastic band 800. The top surface of the first elastic band 800 includes an aperture 801 that is formed from the intersection of the depression 800 with the top surface of the first elastic band 800. The size and shape of the aperture 801 and depression 802 may be configured such that an insert 100 may be inserted through the aperture 801 and into the depression 802. All or a portion of the first elastic band 800 may be comprised of a transparent material.

Reference is now made to FIG. 5B which shows an isometric view of an elastic wristband 804 with a secondary molding 803 in one embodiment to the present invention. In this embodiment, the secondary molding 803 has been molded to the top surface of the first elastic band 800. In this manner, the secondary molding 803 may cover the aperture 801 and serve to contain the insert 100 within the depression 802.

When a single embodiment is described herein, it will be readily apparent that more than one embodiment may be used in place of a single embodiment. Similarly, where more than one embodiment is described herein, it will be readily apparent that a single embodiment may be substituted for that one device.

In light of the wide variety of possible devices and methods, the detailed embodiments are intended to be illustrative only and should not be taken as limiting the scope of the invention. Rather, what is claimed as the invention is all such modifications as may come within the spirit and scope of the following claims and equivalents thereto.

None of the description in this specification should be read as implying that any particular element, step or function is an essential element which must be included in the claim scope. The scope of the patented subject matter is defined only by the allowed claims and their equivalents. Unless explicitly recited, other aspects of the present invention as described in this specification do not limit the scope of the claims.

What is claimed is:

1. A wristband with an insert comprising:
an RFID chip and an antennae;
an insert consisting of a first elongated plate and a second elongated plate, wherein the first elongated plate includes connecting mechanism for removably connecting the first elongated plate to the second elongated plate, wherein the first elongated plate includes a recess disposed to receive the RFID chip and the antennae; and
a wristband configured to receive the insert after the first elongated plate has been removably connected to the second elongated plate.

2. The wristband of claim 1 wherein the second elongated plate also includes a recess disposed to receive the RFID chip and the antennae.

3. The wristband of claim 1 wherein the second elongated plate also includes a connecting mechanism for removably connecting the second elongated plate to the first elongated plate.

4. The wristband of claim 3, wherein the connecting mechanism for removably connecting the first elongated plate to the second elongated plate is a post and the connecting mechanism for removably connecting the second elongated plate to the first elongated plate is a receptacle, wherein the post is adapted to fit securely within the receptacle so that the first elongated plate is removably connected to the second elongated plate.

5. The wristband of claim 1 wherein the connecting mechanism is located between the first elongated plate and the second elongated plate when the first elongated plate is connected to the second elongated plate.

6. The wristband of claim 1 wherein the first elongated plate and the second elongated plate are curved.

7. The wristband of claim 1 wherein the first elongated plate and the second elongated plate are not curved.

8. The wristband of claim 1 wherein the first elongated plate includes attachments for securing the RFID chip and the antennae inside the recess.

9. The wristband of claim 1 wherein the first elongated disk is comprised of one or more of the following materials: thermal plastic elastomers, polyvinyl chloride, poly carbonate, styrene, acrylonitrile butadiene styrene, polypropylene and polyethylene.
